(19) United States
(12) Patent Application Publication
(10) Pub. No.: US 2011/0000013 A1
(43) Pub. Date: Jan. 6, 2011

(54) Spa Shell

(76) Inventor: Joseph G. Elnar, Riverside, CA (US)

Correspondence Address: AVERILL & GREEN, 8244 PAINTER AVE., WHITTIER, CA, 90602, US

(21) Appl. No.: 12/498,225

(22) Filed: Jul. 6, 2009

(51) Int. Cl. A47K 3/02; B29C 51/10

(52) U.S. Cl. 4/584; 264/292

(57) ABSTRACT

An improved spa shell is vacuum formed using a mold and removable edge parts. The edge parts are positioned on a shoulder surrounding a top edge of the mold. A sheet of plastic is heated and pulled down over the mold and edge parts by clamps. Vacuum is drawn from the interior of the mold for forming the shell interior and through the edge parts to draw the plastic into a channel surrounding the spa shell edge to form a belt and recessed lip. After cooling, the shell is lifted away from the mold, also separating the edge parts from the mold. The edge parts are then free to extract from the shell. The formed shell may be assembled with a spa frame, and wall pieces removably positioned around the exterior of the spa by engaging the recessed lip.

### BACKGROUND OF THE INVENTION

The present invention relates to spa manufacturing and in particular to manufacturing an improved spa shell.

Spa shells generally are formed with a rough outer edge. The edges are trimmed and then attached to a spa base using screws or similar fasteners around the edge of the spa shell, and the trimmed edges remain exposed on the completed spa. Obtaining a smooth and properly shaped edge can be difficult and time consuming, and because the edge is exposed, any errors are very apparent to users.

### BRIEF SUMMARY OF THE INVENTION

The present invention addresses the above and other needs by providing an improved spa shell which is vacuum formed using a mold and removable edge parts. The edge parts are positioned on a shoulder surrounding a top edge of the mold. A sheet of plastic is heated and pulled down over the mold and edge parts by clamps. Vacuum is drawn from the interior of the mold for forming the shell interior and through the edge parts to draw the plastic into a channel surrounding the spa shell edge to form a belt and recessed lip. After cooling, the shell is lifted away from the mold, also separating the edge parts from the mold. The edge parts are then free to extract from the shell. The formed shell may be assembled with a spa frame, and wall pieces removably positioned around the exterior of the spa by engaging the recessed lip.

In accordance with one aspect of the invention, there is provided a method for forming the spa shell according to the present invention. The method includes providing a spa mold comprising a main section and four removable edge parts, positioning the edge parts on an upper lip of the main section, positioning a plastic sheet on top of the mold, positioning the spa mold and plastic sheet into a heated chamber, connecting a vacuum source to a volume between the plastic sheet and an interior of the mold main section, drawing the plastic sheet into the interior of the mold main section and around the edge parts to form a spa shell, lifting the molded spa shell and edge parts away from the mold main section, and extracting the edge parts from the spa shell.

In accordance with another aspect of the invention, there is provided a spa with removable side panels. The side panels include tabs along a top edge to engage a recessed rim of the spa shell. The side panels are easily released by removing screws or other fasteners at a bottom edge, pulling out, and down. The side panels include foam insulation covered by a plastic or fiberglass layer remove with the side panel for easy access to spa equipment. The side panels are thus easily removable and replaceable.

In accordance with yet another aspect of the invention, there is provided a spa cabinet with removable panels. All of the side and corner panels are attached by engaging a concealed recessed lip of the spa shell at the top of the panels, and attaching the bottoms of the panels to a spa frame with screws, hook and loop fasteners, and the like. The panels are easily removed and replaced for spa equipment maintenance, replacement of damaged panels, or to replace all of the panels to change the appearance of the spa.

In accordance with yet another aspect of the invention, there is provided a spa cabinet with removable panels with insulation attached to an inside surface of the panels. The insulation is preferably Styrofoam or a similar material and a plastic or fiberglass backing covers the insulation and is attached to the inside surface of the panels by staples, screws, glue, and the like. Such insulated panels allow removal of spa cabinet fascia and insulation in a single step.

In accordance with yet another aspect of the invention, there is provided a spa with increased resale value because the spa cabinet fascia is easily replaceable and renewable by a buyer.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a spa shell according to the present invention.

FIG. 2 a cross-sectional view of an upper edge of the spa shell showing a belt and recessed lip according to the present invention.

FIG. 3 is a side view of a spa including the spa shell according to the present invention.

FIG. 4 is a perspective view of a spa frame for the spa shell, according to the present invention.

FIG. 5A is a side view of the spa frame for the spa shell, according to the present invention.

FIG. 5B is a top view of the spa frame for the spa shell, according to the present invention.

FIG. 6A is a perspective view of a portion of a spa frame according to the present invention.

FIG. 6B is a perspective view of a portion of the spa frame according to the present invention with straight and curved wall pieces according to the present invention in place.

FIG. 7 is a front view of the straight wall piece according to the present invention.

FIG. 8 is an edge view of the straight wall piece according to the present invention.

FIG. 9 is a detailed view of the cooperation of the spa shell, the spa frame, and the straight wall piece according to the present invention.

FIG. 10 is an exploded perspective view of a spa shell mold and removable edge parts according to the present invention.

FIG. 11 is a view of the spa shell mold with the removable edge parts positioned for molding the spa shell according to the present invention.

FIG. 12 is a view of a plastic sheet positioned over the spa shell mold and the removable edge parts.

FIG. 13 is a view of a plastic sheet pulled down over the spa shell mold and the removable edge parts.

FIG. 14 is a view of a plastic sheet drawn into place over the spa shell mold and the removable edge parts.

FIG. 15 is a method for forming the spa shell according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

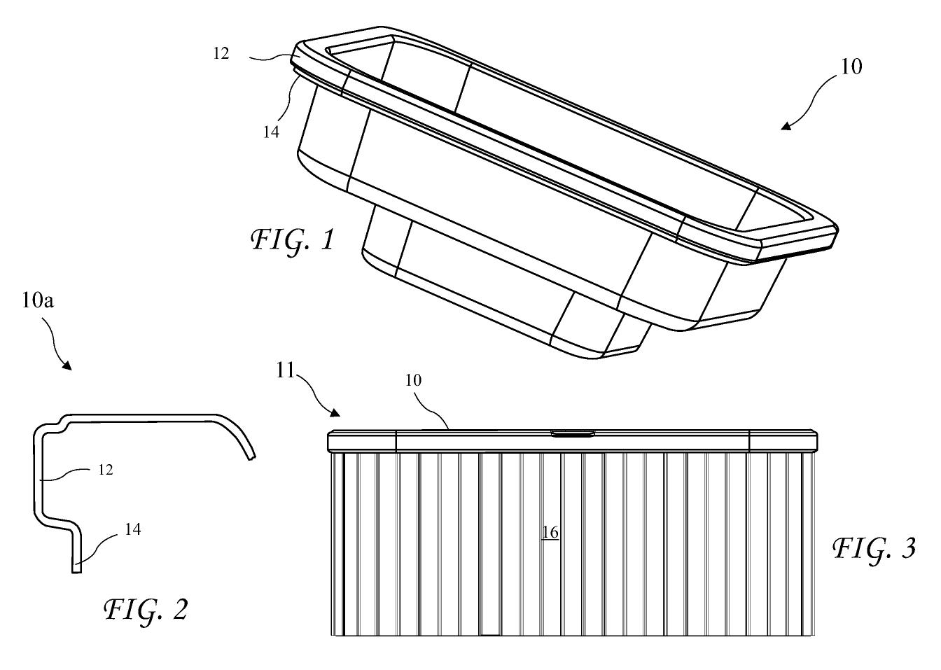

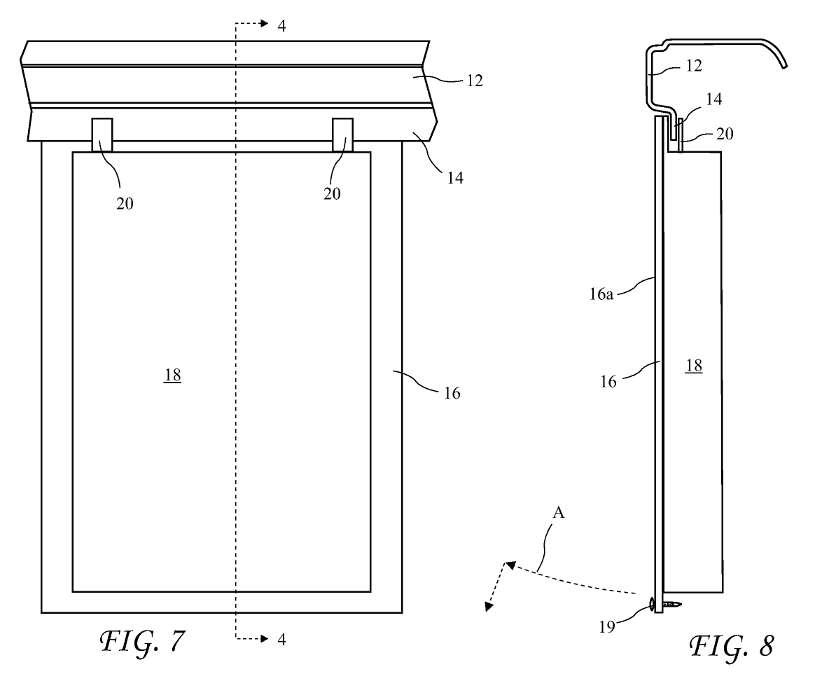

A spa shell 10 according to the present invention is shown in FIG. 1, a cross-sectional view of an outside top edge 10a of the spa shell showing a belt 12 and a recessed lip 14 according to the present invention is shown in FIG. 2, and a side view of a spa 11 according to the present invention, including the spa shell 10 according to the present invention, is shown in FIG. 3. Known spa shells includes a horizontal lip which is exposed after assembly. Any flaws in the horizontal lip creates both an unsightly appearance and may snag swim suits of bathers sitting on the spa edge. Wall pieces 16 of the spa 11 vertically engage the recessed lip 14 of the spa shell 10 (see FIGS. 6 and 7) to address the problems with known spas.

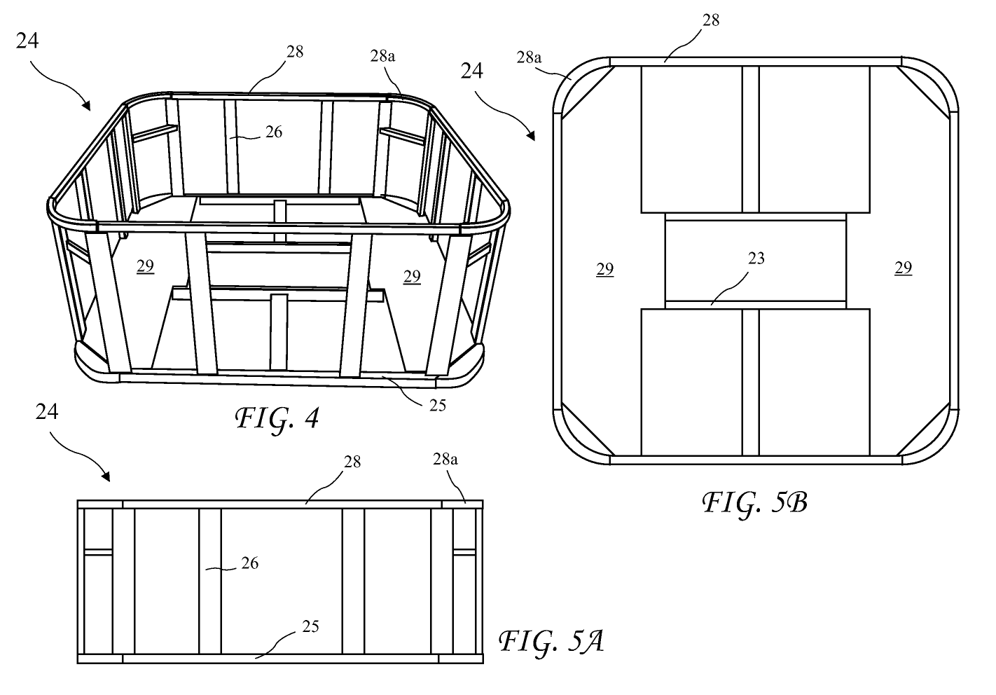

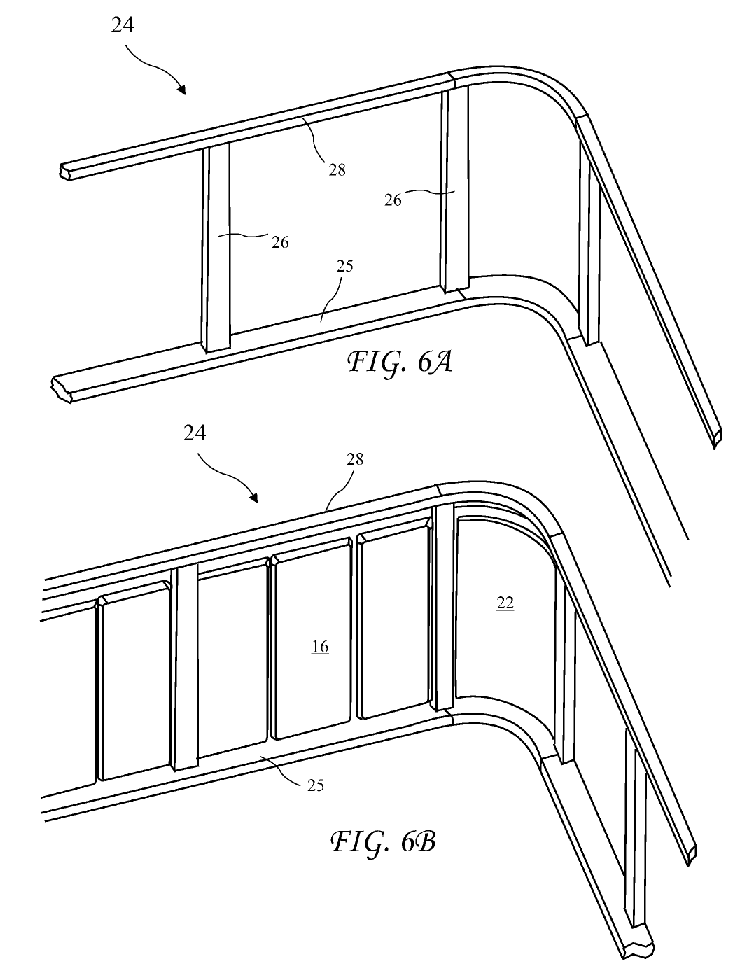

A perspective view of a spa frame 24 according to the present invention, for the spa shell 10, is shown in FIG. 4, a side view of the spa frame 24 is shown in FIG. 5A, and a top view of the spa frame 24 is shown in FIG. 5B. The spa frame 24 includes top rails 28, bottom rails 25, and vertical posts 26 connecting the top rails 28 to the bottom rails 25. Partial floor sections 29 are attached to bottom framing 23. The bottom may remain open, or be closed by a combination of Styrofoam and fiberglass panels, with a sheet of plastic covering the bottom side of the spa bottom.

A perspective view of a portion of a spa frame 24 according to the present invention is shown in FIG. 6A and a perspective view of a portion of the spa frame 24 according to the present invention, with straight and curved wall pieces 16 and 22 according to the present invention in place, is shown in FIG. 6B. The straight and curved wall pieces 16 and 22 engage the spa shell 10 at the top and are attached with screw, hook and loop fasteners, or the like at the bottom to hold the straight and curved wall pieces 16 and 22 in place. The straight and curved wall pieces 16 and 22 may thus easily be removed for maintenance to reduce costs. The straight wall pieces 16 are preferably a single wide piece on each of the four sides of the spa.

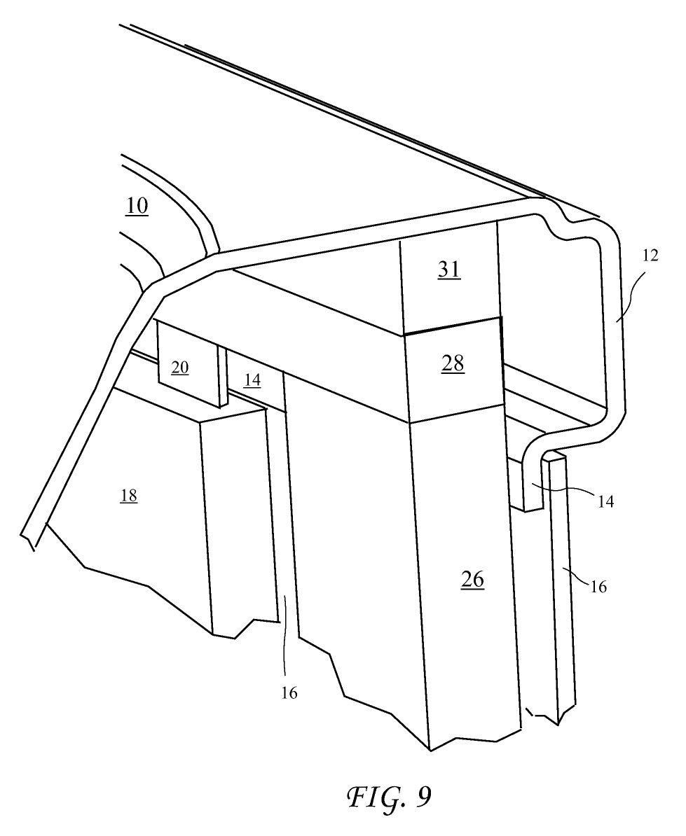

A rear view of the straight wall piece 16 engaging the recessed edge 14 of the spa shell according to the present invention is shown in FIG. 7 and an edge view of the straight wall piece 16 is shown in FIG. 8 with tabs 20 engaging the recessed lip 14 of the spa shell 10 at the top of the straight wall piece 16. Insulation panel 18 resides on the inner (or rear) side of the straight and curved wall pieces 16 and 22 and is removed with the wall pieces 16 and 22 to perform maintenance on the spa. The insulation panel 18 is preferably a foam panel sealed by a fiberglass layer over the foam. The tabs 20 reach upward to engage the recessed lip 14. The straight wall pieces 16 swing out at the base along an arc A and are dropped to disengage from the recessed lip 14. Alternatively, a single wide ridge along most of the length of the top of the insulation panel 18 may engage the recessed lip 14. The straight wall piece 16 is attached to the bottom rail 25 of the spa frame 28 at the bottom by a screw 19, or alternatively by a hook and loop fastener or the like. An outer surface 16a of the straight wall piece 16 is decorative to provide the desired appearance, and may have a wood texture and color or other decorative features. The outer surface 16a may be wood, plastic, or metal and the insulation panel 18 may be attached to the outer surface by staples, screws, glue, and the like. The curved wall pieces 16 preferably have the same construction as the straight wall pieces.

A detailed view of the cooperation of the spa shell 10, the spa frame 24, and the straight wall piece 16 is shown in FIG. 9. A wood, or similar material, assembly rail 31 is molded into or to the spa shell 10 during final manufacture of the spa shell. The top rail 28 of the frame is attached to the assembly rail 31 by wood screws or the like. Generally, the spa shell 10 is inverted resting on a horizontal surface. The frame 24 is then inverted and positioned over the spa shell with the top rail 28 resting against the assembly rail 31. Then screws are inserted through the top rail 28 and into the assembly rail 31 to attached the frame 24 to the spa shell 10. After the frame 24 is attached to the spa shell 10, the four corner wall pieces 22 may easily be attached to the frame 24 and spa shell 10, and then the side wall pieces 16 may be attached. The straight wall pieces 16 covers the recessed lip 14 of the spa shell 10 and the tab 20 extending upward from the insulation panel 18 sandwiches the recessed lip 14 to retain the top of the straight wall piece 16 in position.

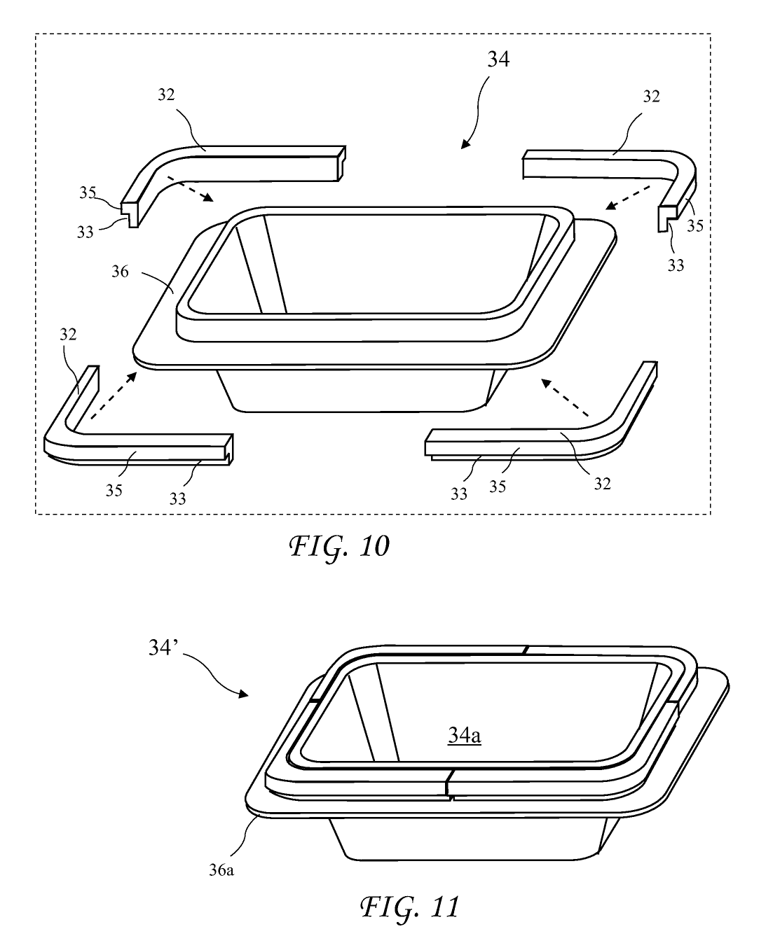

An exploded perspective view of a spa shell mold 34 and removable edge parts 32 according to the present invention is shown in FIG. 10 and a view of the spa shell mold 34 with the removable edge parts 32 positioned for molding the spa shell 10 according to the present invention is shown in FIG. 11. The mold 43 includes a horizontal shelf 36 just below the top edge and the removable edge parts 32 rest on the shelf. The outer faces 35 of the removable edge parts 32 form a surface for molding the belt 12 and recessed portions 33 for molding the recessed lip 14 of the spa shell 10. Vacuum passages are provided in the removable edge parts 32 which connect either to vacuum lines, or to the interior 34a of the mold 34.

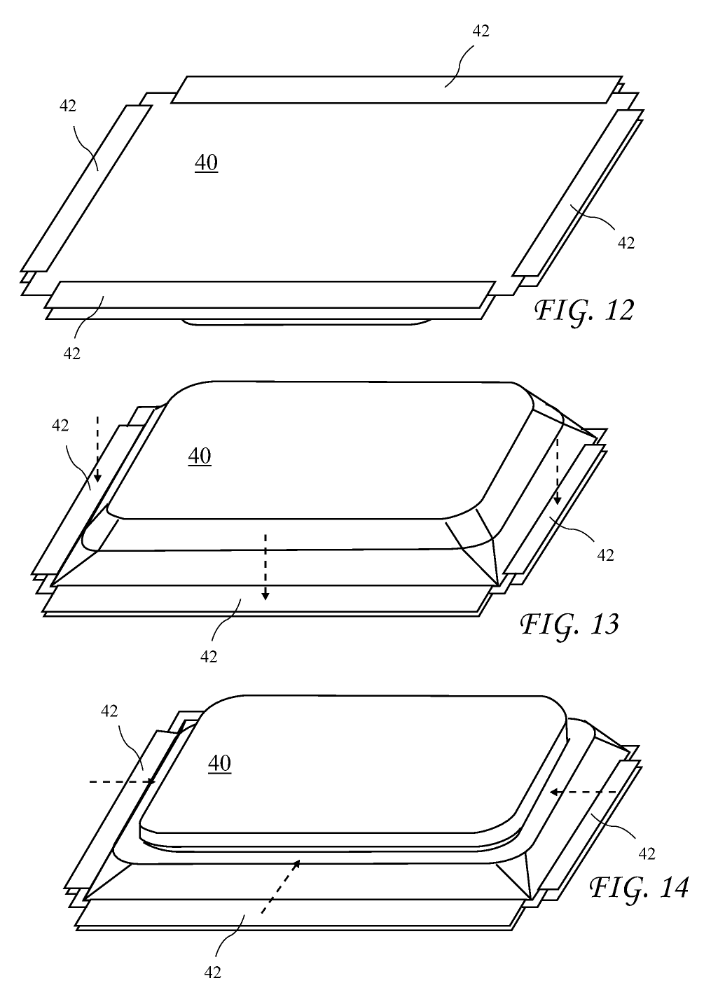

A view of a plastic sheet 40 positioned over the spa shell mold 34 and the removable edge parts 32 is shown in FIG. 12, a view of a plastic sheet 40 pulled down over the spa shell mold 34 and the removable edge parts 32 is shown in FIG. 13, and a view of a plastic sheet 40 drawn into place over the spa shell mold 34 and the removable edge parts 32 is shown in FIG. 14. The plastic sheet 40 is held by clamps 42 which may be raised or lowered as needed. Initially, the clamps 42 hold the plastic sheet 40 above the mold 34. The clamps 42 are then used to lower the plastic sheet 40 over the spa shell mold 34 and the removable edge parts 32 and to stretch the plastic sheet 40 over the horizontal shelf 36 and to form somewhat of a seal around the edge 36a of the horizontal shelf 36 (see FIG. 11). The mold and plastic sheet may then be placed in an oven to heat the plastic sheet, and a vacuum drawn from the interior 34a of the mold 34, and through the edge parts 32, to draw the plastic sheet into the interior 43a to form the interior of the spa, and to conform to the outside profile of the edge parts 32 to form the belt 12 and the recessed lip 14.

Importantly, after the plastic cools in it's final shape, the clamps 42 may be used to raise the newly formed spa shell above the mold, and then the edge parts 32 may be removed.

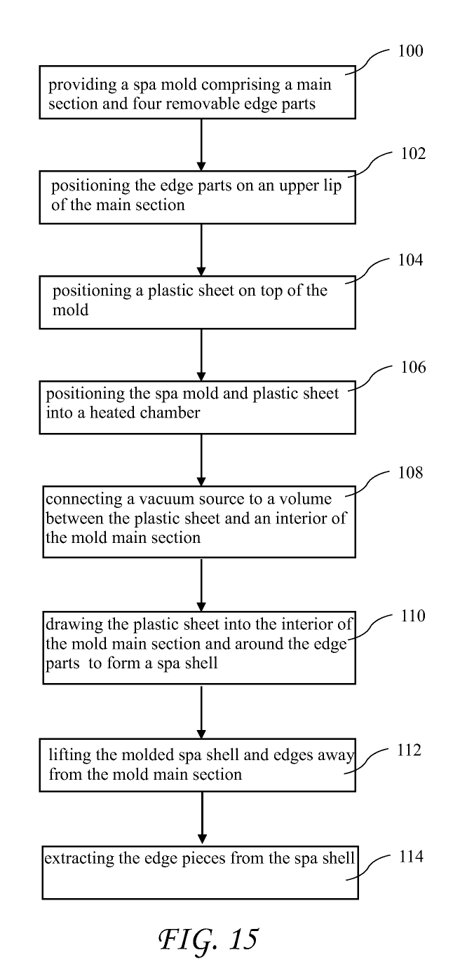

A method for forming the spa shell 10 according to the present invention is described in FIG. 15. The method includes providing a spa mold comprising a main section and four removable edge parts, positioning the edge parts on an upper lip of the main section, positioning a plastic sheet on top of the mold, positioning the spa mold and plastic sheet into a heated chamber, connecting a vacuum source to a volume between the plastic sheet and an interior of the mold main section, drawing the plastic sheet into the interior of the mold main section and around the edge parts to form a spa shell, lifting the molded spa shell and edge parts away from the mold main section, and extracting the edge parts from the spa shell.

While the invention herein disclosed has been described by means of specific embodiments and applications thereof, numerous modifications and variations could be made thereto by those skilled in the art without departing from the scope of the invention set forth in the claims.

1. A method for molding a spa shell, the method comprising:
providing a spa mold comprising a main section and four removable edge parts;
positioning the edge parts on an outside upper lip of the main section;
positioning a plastic sheet on top of the mold;
positioning the spa mold and plastic sheet into a heated chamber;
connecting a vacuum source to a volume between the plastic sheet and an interior of the mold main section;
drawing the plastic sheet into the interior of the mold main section and around the edge parts to form a spa shell;
lifting the molded spa shell and edge parts away from the mold main section;
extracting the edge parts from the spa shell;
trimming a recessed lip of the spa shell to finish the spa shell;
molding an assembly rail into the interior of the outer top edge of the spa shell;
positioning a spa frame with a top rail of the spa frame against the assembly rail;
attaching the top rail to the assembly rail;
positioning wall pieces with the recessed lip of the spa shell sandwiched between an upper edge of each of the wall piece outside the recessed lip and tabs attached to each of the wall piece inside the recessed lip; and
removably attaching a bottom edge of each of the wall pieces to the frame.

2-10. (canceled)

11. A spa comprising:
a free standing spa frame having a top rail and a bottom rail;
a spa shell comprising:
an interior for holding water and bathers;
an outside top edge forming a closed upper perimeter of the spa shell;
an outer most vertical belt portion of the outside top edge; and
a recessed lip below and recessed in from belt portion;
a spa wall enclosing the spa and at least partially covering the recessed lip and comprising wall pieces separately removably attached to the spa frame at bases of the wall pieces.

12. The spa of claim 11, wherein:
an assembly rail is permanently attached inside the outside top edge of the spa shell; and
the top rail of the spa frame is attached to the assembly rail.

13. The spa of claim 11, wherein insulation is attached to inside surfaces of the wall pieces and is removable from the spa with the spa pieces.

14. The spa of claim 13, wherein the insulation is Styrofoam insulation.

15. The spa of claim 13, wherein a cover is attached to the wall pieces over the insulation covering the insulation.

16. The spa of claim 11, wherein the wall pieces sandwich the recessed lip of the spa shell between an exposed top edge of the wall piece and tabs spaced back from the top edge.

17. The spa of claim 11, wherein the wall pieces comprise rounded corner pieces and flat side pieces.

18. A method for molding a spa shell, the method comprising:
providing a spa mold comprising a main section and four removable edge parts;
positioning the edge parts on an outside upper lip of the main section;
positioning a plastic sheet on top of the mold;
positioning the spa mold and plastic sheet into a heated chamber;
connecting a vacuum source to a volume between the plastic sheet and an interior of the mold main section;
drawing the plastic sheet into the interior of the mold main section and around the edge parts to form a spa shell;
lifting the molded spa shell and edge parts away from the mold main section; and
extracting the edge parts from the spa shell.

19. The method of claim 18, further including connecting the vacuum source to the edge parts to draw vacuum to draw the plastic sheet into recessed portions of the edge parts to form a recessed lip around an outer top edge of the spa shell.

20. The method of claim 19, further including trimming the recessed lip to finish the spa shell.

21. The method of claim 18, further including molding an assembly rail into the interior of the outer top edge of the spa shell.

22. The method of claim 21, further including:
positioning a spa frame with a top rail of the spa frame against the assembly rail; and
attaching the top rail to the assembly rail.

23. The method of claim 22, further including:
positioning wall pieces with the recessed lip of the spa shell sandwiched between an upper edge of the wall piece outside the recessed lip and tabs attached to the wall piece inside the recessed lip; and
removably attaching a bottom edge of the wall pieces to the frame.

24. The method of claim 23, further including removing and replacing the wall pieces for maintenance of the spa.

25. The method of claim 23, further including removing and replacing the wall pieces for replacement of damaged wall pieces.

26. The method of claim 23, further including removing and replacing the wall pieces for changing the appearance of the spa.

27. The method of claim 23, wherein attaching wall pieces comprises attaching wall pieces with insulation permanently attached to an inside surface of the wall pieces.

28. The method of claim 1, wherein positioning wall pieces comprises positioning wall pieces with permanently attached insulation with the recessed lip of the spa shell sandwiched between an upper edge of each of the wall piece outside the recessed lip and tabs attached to each of the wall piece inside the recessed lip.

29. The method of claim 1, wherein positioning wall pieces comprises position rounded corner all pieces and straight side wall pieces with the recessed lip of the spa shell sandwiched between an upper edge of each of the wall piece outside the recessed lip and tabs attached to each of the wall piece inside the recessed lip.
